(19) United States
(12) Patent Application Publication
(10) Pub. No.: US 2015/0124147 A1
(43) Pub. Date: May 7, 2015

(54) METHOD OF DISPLAYING HIGH DYNAMIC RANGE (HDR) IMAGE, COMPUTER-READABLE STORAGE MEDIUM FOR RECORDING THE METHOD, AND DIGITAL IMAGING APPARATUS

(71) Applicant: SAMSUNG ELECTRONICS CO., LTD., Suwon-si (KR)

(72) Inventor: Seung-yun Lee, Hwaseong-si (KR)

(21) Appl. No.: 14/526,813

(22) Filed: Oct. 29, 2014

(30) Foreign Application Priority Data
Nov. 1, 2013 (KR) 10-2013-0132536

(51) Int. Cl. H04N 5/232; G06T 3/40; G06T 5/00

(52) U.S. Cl. CPC H04N 5/23293; H04N 5/23216; G06T 5/001; G06T 3/40; G06T 2207/10004; G06T 2207/20208
USPC 348/333.11

(57) ABSTRACT

A method of displaying a high dynamic range (HDR) image is described. An HDR mode is entered based on a user input. A preview image is received. An HDR image is obtained based on the received preview image. The obtained HDR image and the preview image are displayed together.

### CROSS-REFERENCE TO RELATED PATENT APPLICATIONS

This application claims the benefit of Korean Patent Application No. 10-2013-0132536, filed on Nov. 1, 2013, in the Korean Intellectual Property Office, the disclosure of which is incorporated herein in its entirety by reference.

### BACKGROUND

1. Field

One or more embodiments of the present description relate to a method of displaying a high dynamic range (HDR) image by using a preview image, a computer-readable storage medium for recording the method, and a digital imaging apparatus.

2. Related Art

A dynamic range of an image refers to a range in which a luminance level of an image, ranged from a light area to a dark area, may be represented. A dynamic range may be adjusted by changing pixel values which indicate brightness, such as luminance, of an image. A method of implementing a high dynamic range (HDR), which has been recently described, may be largely classified into three types as follows.

One is a technology for enhancing a dynamic range and image quality of image data, which is output from an image sensor, by using an algorithm in image signal processing. Representative technologies thereof may include gamma correction and retinex image enhancement.

Another one is a technology for improving a dynamic range by obtaining two or more images having different amounts of exposure and synthesizing the images with each other. The images may be obtained by taking two pictures at different shutter speeds. Then, the images are synthesized and corrected by using a proper image signal processing algorithm.

The other one is a technology for obtaining two pieces of image data by disposing a pixel on another pixel, which have different sensitivities from each other, in an image sensor. Pixel data generated from pixels, having different sensitivities with the same amount of exposure time, has the same effect as image data which is generated with different amounts of exposure from each other. This technology is to obtain a high dynamic range image by synthesizing and correcting the two pieces of image data, which are generated by using the two pixels.

### SUMMARY

One or more embodiments of the present description include a method of obtaining a high dynamic range (HDR) image by using a preview image and displaying the obtained HDR image and the preview image.

Various embodiments are set forth in part in the description which follows and, in part, will be apparent from the description, or may be learned by practice of the presented embodiments.

According to one or more embodiments, a method of displaying a HDR image includes: entering a HDR mode based on a user input; receiving a preview image; obtaining a HDR image based on the received preview image; and displaying the obtained HDR image and the preview image together.

The method further include providing a first user interface, via which a user may select whether to enter the HDR mode.

The obtaining of the HDR image may include: generating a first image by resizing the preview image; generating a second image by performing exposure compensation processing based on the generated first image; and obtaining the HDR image by synthesizing the first image with the second image.

The method further include providing a second user interface, via which a user may set at least one of a set value for a size of the first image or an exposure compensation value of the second image.

The method further include providing a third user interface, via which a user may select whether to display the HDR image.

According to one or more embodiments, a digital imaging apparatus includes: a user input unit that receives an input of a signal for entering a HDR mode; an image reception unit that receives a preview image; an imaging unit that obtains a HDR image by image-processing the preview image that is received by the image reception unit; and a control unit that controls to display the HDR image, which is obtained by the imaging unit, and the preview image together on a display unit.

At least one of a location or a size of the HDR image, which is displayed with the preview image together, may be changeable based on a user input.

The control unit may control to display a first user interface, via which a user may select whether to enter the HDR mode, on the display unit, and the user input unit may receive an input of a selection of whether to enter the HDR mode.

The imaging unit may include: a resizing unit that resizes the preview image that is received by the image reception unit, and thus generates a first image; an exposure compensation processing unit that performs exposure compensation processing based on the first image that is generated by the resizing unit, and thus generates a second image; and an image synthesis unit that synthesizes the first image that is generated by the resizing unit with the second image that is generated by the exposure compensation processing unit, and thus obtains the HDR image.

The control unit may control to display a second user interface, via which a user may set at least one of a set value for a size of the first image or an exposure compensation value for the second image, on the display unit, and the user input unit may receive an input of a selection of at least one of a set value for a size of the first image and an exposure compensation value for the second image, on the display unit.

The control unit may control a third user interface, via which a user may select whether to display the HDR image, on the display unit. and the user input unit may receive an input of the selecting of whether to display the HDR image.

According to one or more embodiments, a non-transitory computer-readable storage medium having stored thereon a computer program, which when executed by a computer, performs a method of displaying an HDR image, the method includes entering an HDR mode based on a user input; receiving a preview image; obtaining an HDR image based on the received preview image; and displaying the obtained HDR image and the preview image together.

At least one of a location or a size of the HDR image, which is displayed with the preview image together, may be changeable based on a user input.

The method may further include providing a first user interface, via which a user may select whether to enter the HDR mode.

The obtaining of the HDR image may include: generating a first image by resizing the preview image; generating a second image by performing exposure compensation processing based on the generated first image; and obtaining the HDR image by synthesizing the first image with the second image.

The method may further include providing a second user interface, via which a user may set at least one of a set value for a size of the first image and an exposure compensation value of the second image.

The method may further include providing a third user interface, via which a user may select whether to display the HDR image.

### BRIEF DESCRIPTION OF THE DRAWINGS

These and/or other embodiments will become apparent and more readily appreciated from the following description of various embodiments, taken in conjunction with the accompanying drawings in which:

FIG. 1 is a block diagram of a digital imaging apparatus for displaying a preview image and a high dynamic range (HDR) image together according to an embodiment;

FIG. 2 is a flowchart of a method of displaying an HDR image together with a preview image according to an embodiment;

FIG. 3 illustrates an example of displaying a preview image and an HDR image together on a display unit, which is performed by a digital imaging apparatus, according to an embodiment;

FIG. 4 is a flowchart of a method of entering an HDR mode and displaying an HDR image, according to an embodiment;

FIG. 5 illustrates an example of displaying a first user interface, via which a user may select whether to enter an HDR mode, on the display unit, which is performed by the digital imaging apparatus according to an embodiment;

FIG. 6 is a block diagram of the digital imaging apparatus for obtaining an HDR image by using a preview image, according to an embodiment;

FIG. 7 is a flowchart of a method of obtaining an HDR image by using a preview image, according to an embodiment;

FIG. 8 is a diagram illustrating an example of obtaining an HDR image by using a preview image and displaying the HDR image on the display unit, which is performed by the digital imaging apparatus, according to an embodiment;

FIG. 9 is a flowchart of a method of obtaining an HDR image based on a user input according to an embodiment;

FIG. 10 illustrates an example of displaying a second user interface, via which a user may set a set value of an HDR image, on the display unit, which is performed by the digital imaging apparatus according to an embodiment;

FIG. 11 is a flowchart of a method of displaying an HDR image based on a user input, according to an embodiment; and

FIG. 12 illustrates an example of displaying a third user interface, via which a user may select whether to display an HDR image, on the display unit, which is performed by the digital imaging apparatus according to an embodiment.

### DETAILED DESCRIPTION

Reference will now be made in detail to various embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, change the entire list of elements and do not change the individual elements of the list.

As embodiments of the description allow for various changes and numerous alternative embodiments, particular embodiments are illustrated in the drawings and described in detail in the written description. However, this is not intended to limit embodiments of the present description to particular modes of practice, and it is to be appreciated that all changes, equivalents, and substitutes that do not depart from the spirit and technical scope of embodiments of the present description are encompassed in embodiments of the present description.

While such terms as “first,” “second,” etc., may be used to describe various components, such components must not be limited to the above terms. The above terms are used only to distinguish one component from another.

The terms used in the present specification are merely used to describe particular embodiments, and are not intended to limit embodiments of the present description. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, exemplary embodiments are described in detail with reference to the attached drawings. Like reference numerals in the drawings denote like elements, and thus their description will be omitted.

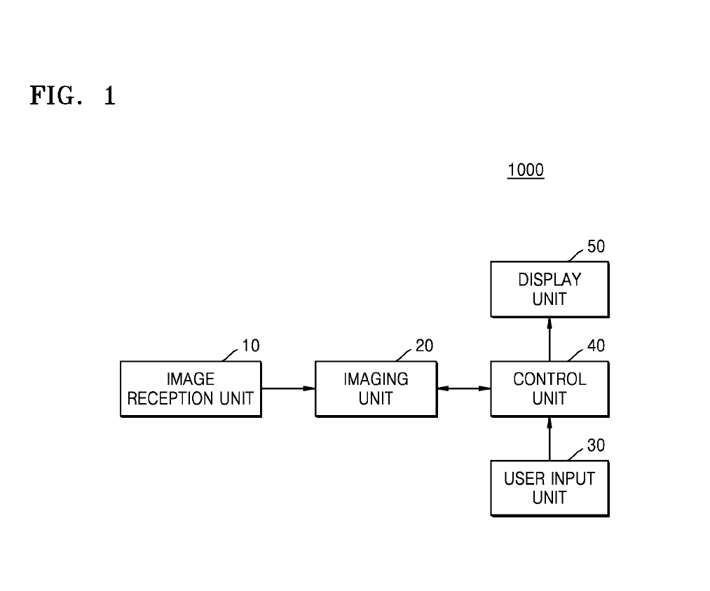

FIG. 1 is a block diagram of a digital imaging apparatus 1000 for displaying a preview image and a high dynamic range (HDR) image together according to an embodiment.

The digital imaging apparatus 1000 may include an image reception unit 10, an imaging unit 20, a user input unit 30, a control unit 40, and a display unit 50.

According to an embodiment, the control unit 40 controls one or more operations of the digital imaging apparatus 1000. The digital imaging apparatus 1000 includes the user input unit 30 that includes a key, button, or the like for generating an electronic signal based on input from a user. The electronic signal that is generated from the user input unit 30 is transmitted to the control unit 40, so that the control unit 40 may control the digital imaging apparatus 1000 according to the input from the user.

According to an embodiment, the control unit 40 may control to display an HDR image, which is obtained from the imaging unit 20, and a preview image together on the display unit 50.

According to an embodiment, the control unit 40 may control to change at least one of a location and a size of an HDR image, which is displayed with a preview image together, based on a user input.

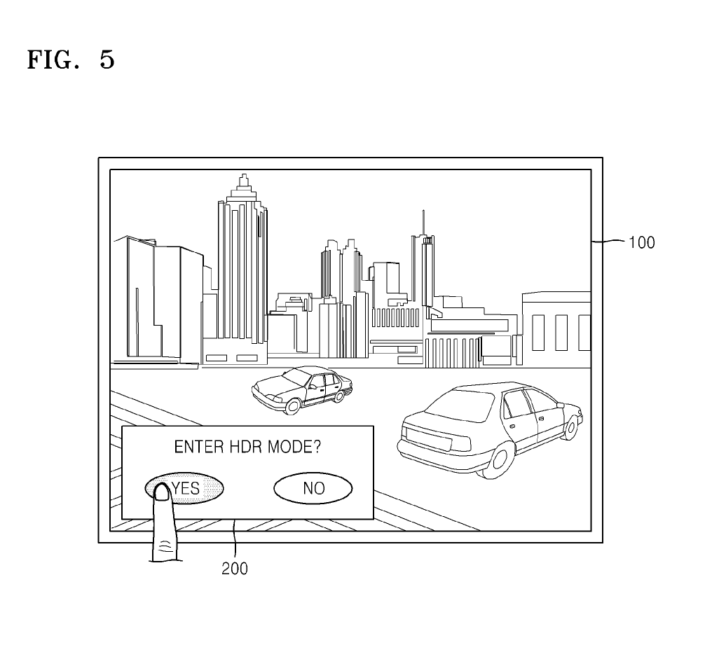

Additionally, according to an embodiment, the control unit 40 may control to display a first user interface, via which a user may select whether to enter an HDR mode, on the display unit 50. The display of the first user interface is described in detail with reference to FIG. 5.

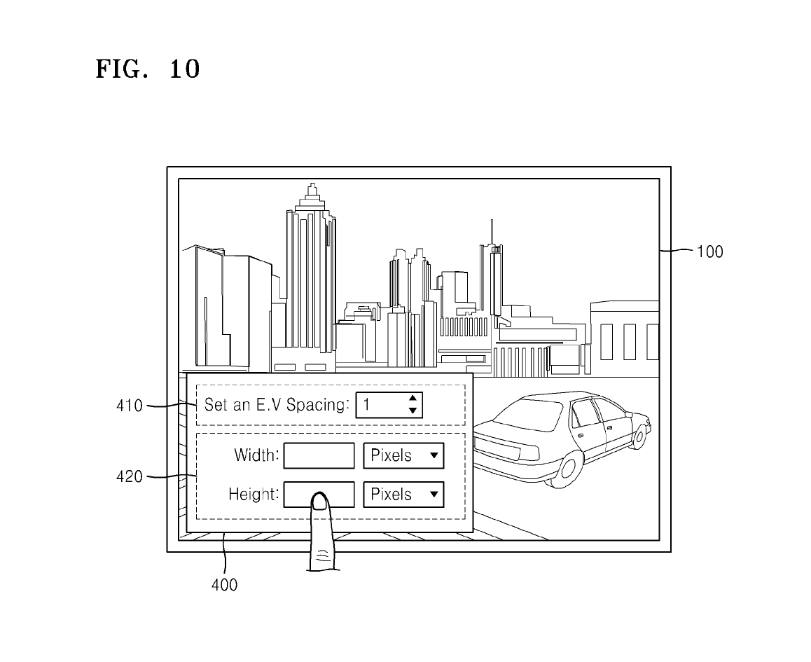

Additionally, according to an embodiment, the control unit 40 may control to display a second user interface, via which a user may set a set value of an HDR image, on the display unit 50. The display of the second user interface is described in detail with reference to FIG. 10.

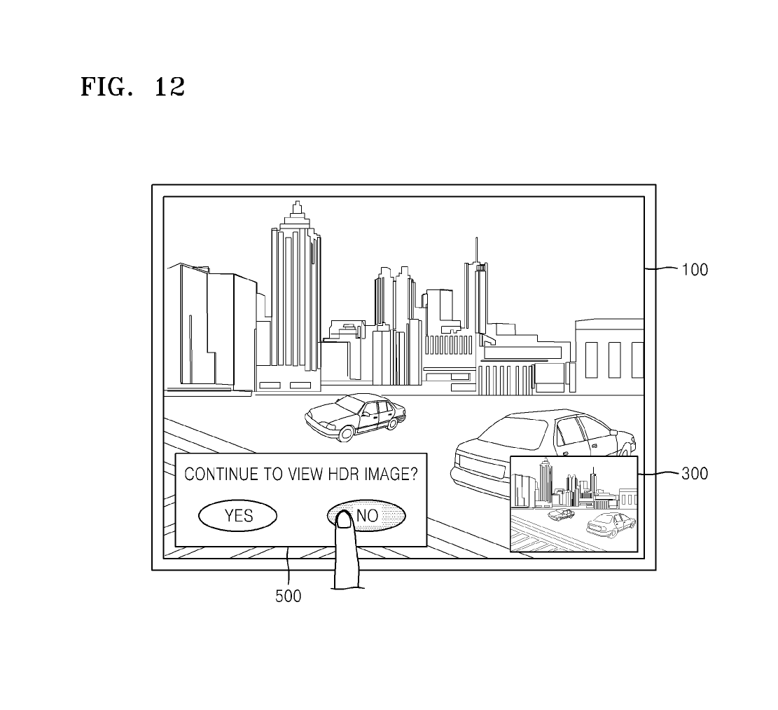

Additionally, according to an embodiment, the control unit 40 may control to display a third user interface, via which a user may select whether to display an HDR image, on the display unit 50. The display of the third user interface is described in detail with reference to FIG. 12.

According to an embodiment, the image reception unit 10 may receive a preview image that is obtained from a camera or other image capture device (not shown) included in the digital imaging apparatus 1000.

According to an embodiment, the imaging unit 20 may perform digital signal processing, such as white balance (WB), color interpolation (CI), or gamma correction, on the preview image that is received by the image reception unit 10.

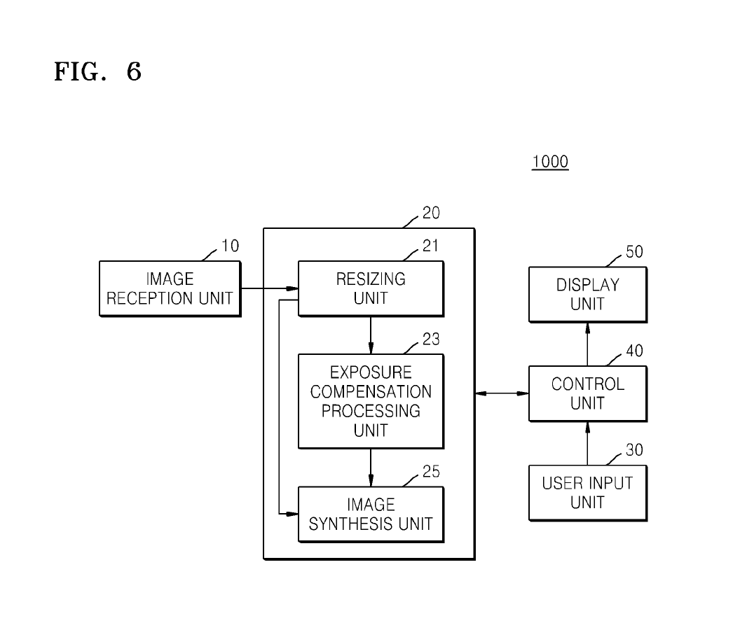

According to an embodiment, the imaging unit 20 may obtain an HDR image by image-processing the preview image that is received from the image reception unit 10. Obtaining the HDR image by image-processing the preview image is described in detail with reference to FIG. 6.

According to an embodiment, the user input unit 30 generates input data for controlling an operation of the digital imaging apparatus 1000. The user input unit 30 may include one or more of a key pad, a dome switch, a touch pad (which may be a capacitive overlay type, a resistive overlay type, an infrared beam type, a surface acoustic wave type, an integral strain gauge type, or a piezo electric type), a jog wheel, or a jog switch, but is not limited thereto. Particularly, if a touch pad and the display unit 50, which is described below, are implemented as a layered structure, such a layered structure may be referred to as a touch screen.

According to an embodiment, the user input unit 30 may receive an input of a signal for changing at least one of a location or a size of an HDR image that is displayed together with a preview image.

According to an embodiment, the user input unit 30 may receive an input of a signal for entering an HDR mode.

Additionally, according to an embodiment, the user input unit 30 may receive an input of a selection of a set value of the HDR image.

For example, according to an embodiment, a set value of an HDR image may include at least one of a set value for a size of a first image for resizing a preview image, or an exposure compensation value of a second image for performing an exposure compensation processing on the first image.

Additionally, according to an embodiment, the user input unit 30 may receive an input of a selection that indicates whether an HDR image is to be displayed.

According to an embodiment, the display unit 50 may include at least one of a liquid crystal display (LCD), a thin-film transistor liquid crystal display (TFT-LCD), an organic light-emitting diode (OLED) display, a flexible display, or a three-dimensional (3D) display.

If the display unit 50 and a touch pad are implemented as a layered structure to form a touch screen, the display unit 50 may be also used as an input unit as well as an output unit. The touch screen may be configured to detect a pressure of a touch input, as well as a location of a touch input and a size of an area of a touch input. Additionally, the touch screen may be configured to detect a proximity touch as well as a real touch.

According to an embodiment, the display unit 50 may display a preview image, received from the image reception unit 10, and an HDR image, obtained from the imaging unit 20, together.

Additionally, according to an embodiment, the display unit 50 may display one or more of a first user interface, a second user interface, a third user interface, or a preview image together.

Operations of the digital imaging apparatus 1000 are now described in detail.

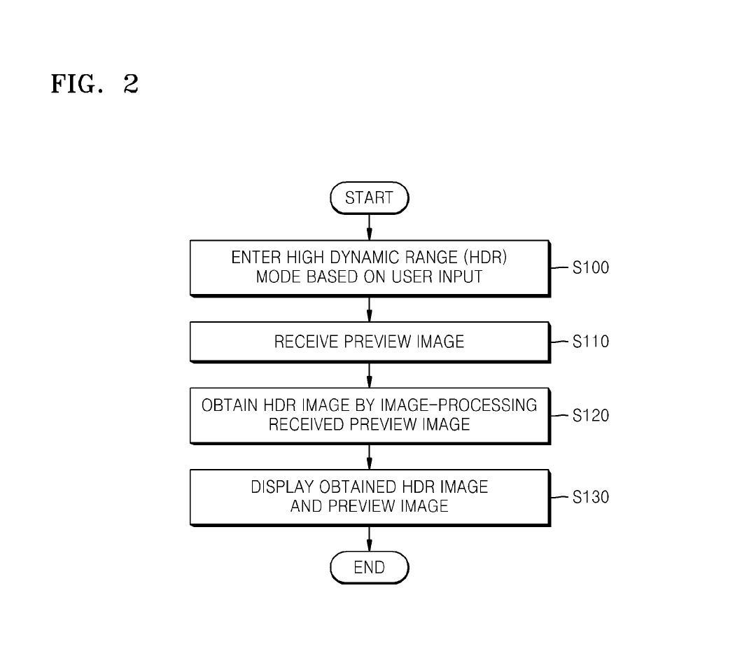

FIG. 2 is a flowchart of a method of displaying a preview image and an HDR image together according to an embodiment.

In operation S100, the digital imaging apparatus 1000 enters an HDR mode based on a user input.

For example, the HDR mode may mean a mode in which an HDR image is obtained by using an input image that is displayed on the display unit 50 included in the digital imaging apparatus 1000.

In operation S110, the digital imaging apparatus 1000 receives a preview image.

In operation S120, the digital imaging apparatus 1000 obtains an HDR image by image-processing the preview image that is received in operation S110.

For example, the preview image that was received in operation S110 is resized, and thus a first image is generated. The generated first image may be a correctly exposed image (e.g., an image with improved exposure). In this case, incorrect exposure compensation is processed based on the correctly exposed first image, and thus a second image may be generated. By synthesizing the correctly exposed first image with the incorrectly exposed second image, the HDR image of which dynamic range is improved may be obtained.

Obtaining the HDR image is described in detail with reference to FIGS. 6 through 10.

In operation S130, the digital imaging apparatus 1000 displays the HDR image, which was obtained in operation S120, and the preview image, which was received in operation S110, together.

According to an embodiment, at least one of a location or a size of the HDR image, which is displayed with a preview image together, may be changed based on a user input.

According to an embodiment, by providing a preview image and the HDR image together to a user before photographing or image capturing, the user may efficiently and intuitively recognize or view an effect of HDR processing. Providing the preview image is described in detail with reference to FIGS. 6 through 10.

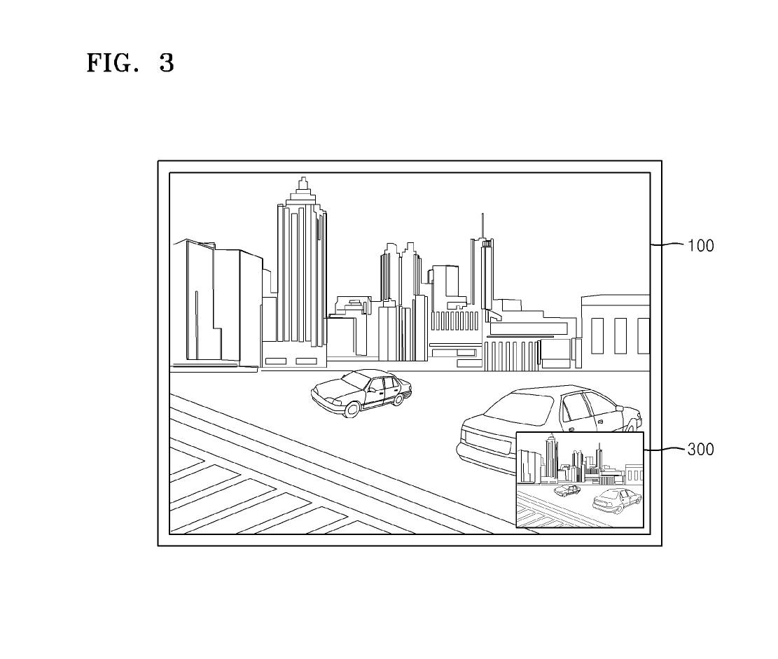

FIG. 3 illustrates an example of displaying a preview image 100 and an HDR image 300 together on the display unit 150, which is performed by a digital imaging apparatus 1000, according to an embodiment.

According to an embodiment, at least one of a location or a size of the HDR image 300, which is displayed with the preview image 100 together on the display 50, may be changed based on a user input.

As shown in FIG. 3, by providing the preview image 100 and the HDR image 300 together to a user before photographing or image capturing, the user may efficiently and intuitively identify or view an effect of HDR processing. Providing the preview image is described in detail with reference to FIG. 3.

Operations of the digital imaging 1000 are now described in detail.

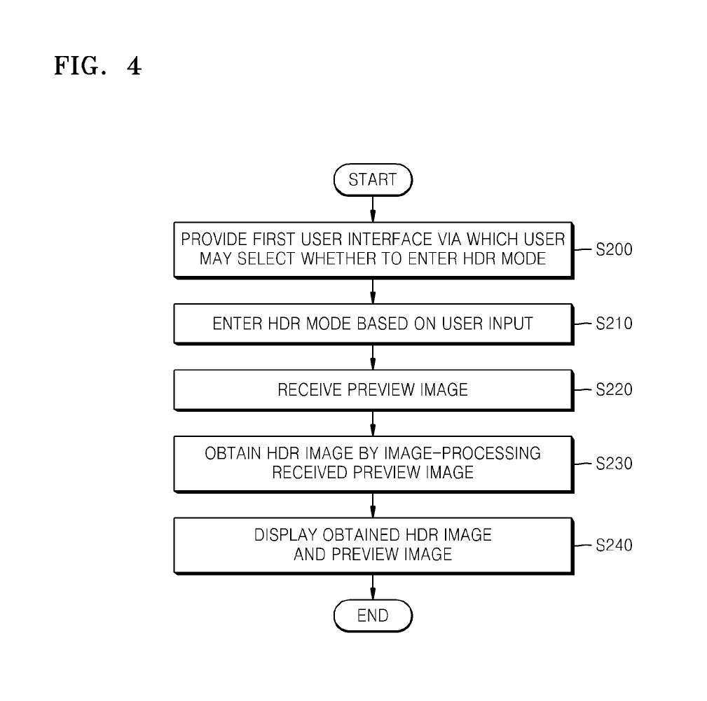

FIG. 4 is a flowchart of a method of entering an HDR mode and displaying an HDR image, according to an embodiment.

In operation S200, the digital imaging apparatus 1000 provides a first user interface, via which a user may select whether to enter the HDR mode. Entering the HDR mode is described in detail with reference to FIG. 5.

In operation S200, if a user selects to enter the HDR mode, operations S210 through S240 correspond to operations S100 through S130, as shown in FIG. 2 and described above. Thus, a detailed description thereof will not be provided here.

FIG. 5 illustrates an example of displaying a first user interface 200, via which a user may select whether to enter the HDR mode, on the display unit 50, which is performed by the digital imaging apparatus 1000 according to an embodiment.

As shown in FIG. 5, while the digital imaging apparatus 1000 displays the preview image 100 on the display unit 50, the control unit 40 may control to display the first user interface 200, via which a user may select whether to enter the HDR mode, on the display unit 50.

For example, if a user selects “Yes” from the first user interface 200, the control unit 40 may control the imaging unit 20 to perform sequential digital imaging processing for obtaining an HDR image, by using the preview image 100 that is displayed on the display unit 50 included in the digital imaging apparatus 1000.

FIG. 6 is a block diagram of the digital imaging apparatus 1000 for obtaining an HDR image by using a preview image, according to an embodiment.

According to an embodiment, the digital imaging apparatus 100 may further include one or more of a resizing unit 21, an exposure compensation processing unit 23, or an image synthesis unit 25.

According to an embodiment, the resizing unit 21 may resize a preview image that is received by the image reception unit 10, thus generating a first image.

For example, the first image may be converted to have a smaller size than the preview image. A width value, a height value, or both a width value and height value for the first image may be stored as a set value for a size of the first image.

In this case, a set value for a size of the first image may be a value (or values) that is automatically set in the HDR mode or a value that is set based on a user input.

According to an embodiment, the exposure compensation processing unit 23 may generate a second image, by performing exposure compensation processing based on the first image that is generated by the resizing unit 21.

For example, the second image may be generated by performing incorrect exposure processing based on the first image. In this case, information about a spacing or difference between exposure values of the first image and the second image may be used as an exposure compensation value of the second image.

In this case, an exposure compensation value of the second image may be a value that is automatically set in the HDR mode or a value that is set based on a user input.

According to an embodiment, the image synthesis unit 25 synthesizes the first image that is generated by the resizing unit 21 with the second image that is generated by the exposure compensation processing unit 23, thus obtaining the HDR image.

For example, by synthesizing the correctly exposed image with the second image that is obtained by performing incorrect exposure compensation processing, the HDR image of which dynamic range is improved may be obtained.

Operations of the digital imaging apparatus 1000 are now described in detail.

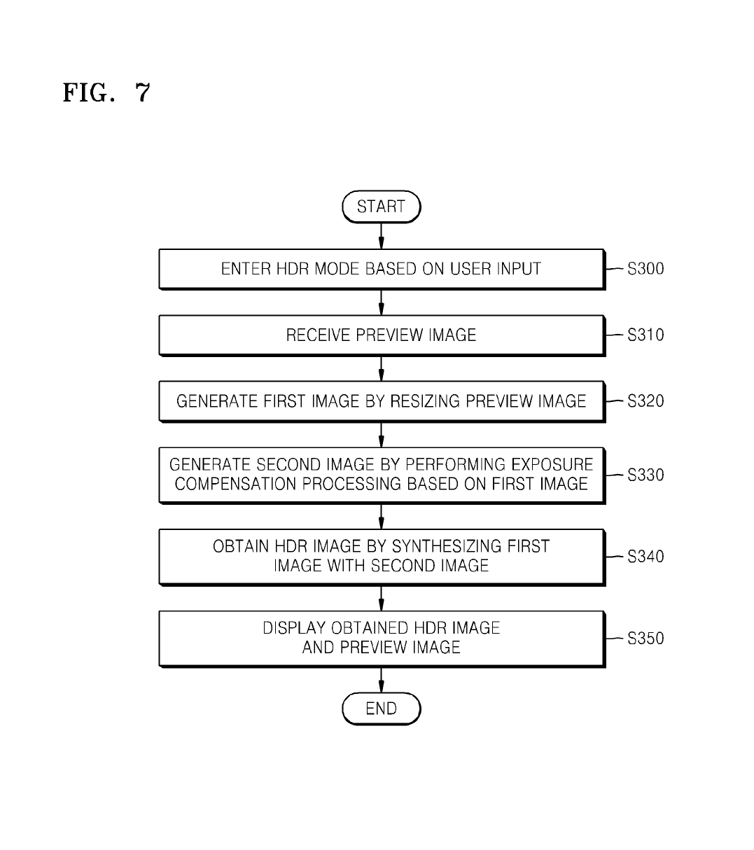

FIG. 7 is a flowchart of a method of obtaining an HDR image by using a preview image, according to an embodiment.

Operations S300, S310, and S350 correspond to operations S100, S110, and S130, shown in FIG. 2 and described above. Thus, a detailed description thereof will not be provided here.

In operation S320, the digital imaging apparatus 1000 resizes a preview image that was received in operation S310, thus generating a first image.

For example, the first image may be converted to have a smaller size than the preview image. One or more of a width value or a height value for the first image may be used as a set value for a size of the first image.

In this case, a set value for a size of the first image may be a value that is automatically set in the HDR mode or a value that is set based on a user input.

In operation S330, the digital imaging apparatus 1000 may perform exposure compensation processing based on the first image that was generated in operation S320, thus generating a second image.

For example, the second image may be generated by performing incorrect exposure processing based on the first image. In this case, information about a spacing or difference between exposure values of the first image and the second image may be used as an exposure compensation value of the second image.

In this case, an exposure compensation value of the second image may be a value that is automatically set in the HDR mode or a value that is set based on a user input.

According to an embodiment, in operation S340, the digital imaging apparatus 1000 synthesizes the first image that was generated in operation S320 with the second image that was generated in operation S330, thus obtaining the HDR image.

For example, by synthesizing the correctly exposed image with the second image that is obtained by performing incorrect exposure compensation processing, the HDR image of which dynamic range is improved may be obtained.

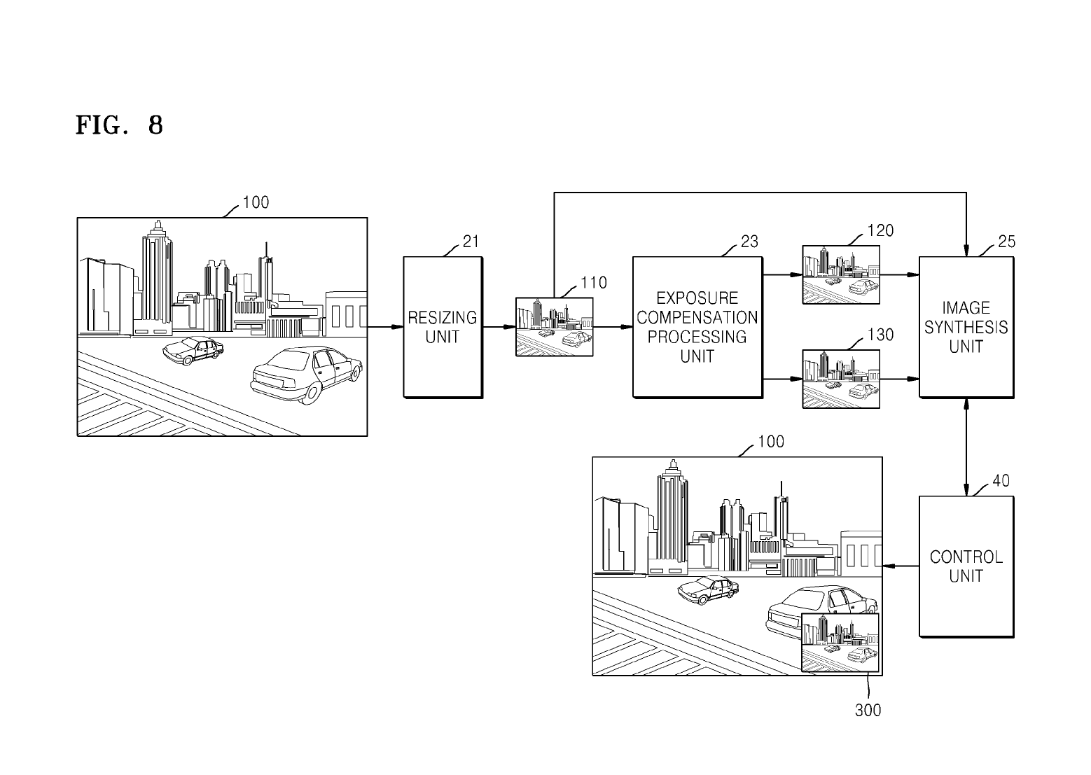

FIG. 8 is a diagram illustrating an example of obtaining an HDR image 300 by using a preview image 100, and displaying the HDR image 300 on the display unit, which is performed by the digital imaging apparatus 1000, according to an embodiment.

As shown in FIG. 8, the preview image 100 may be generated as the first image 110, which is converted to have a smaller size than the preview image 100, by using the resizing unit 21.

Additionally, based on the generated first image 110, second images 120 and 130 may be generated by using the exposure compensation processing unit 23.

In this case, by synthesizing the first image 110 that is generated by using the resizing unit 21 with the second images 120 and 130 that are generated by using the exposure compensation processing unit 23, the HDR 300 image may be obtained.

In this case, the control unit 40 may control to display the obtained HDR image 300 and the preview image 100 together on the display unit 50.

Operations of the digital imaging apparatus 1000 are now described in detail.

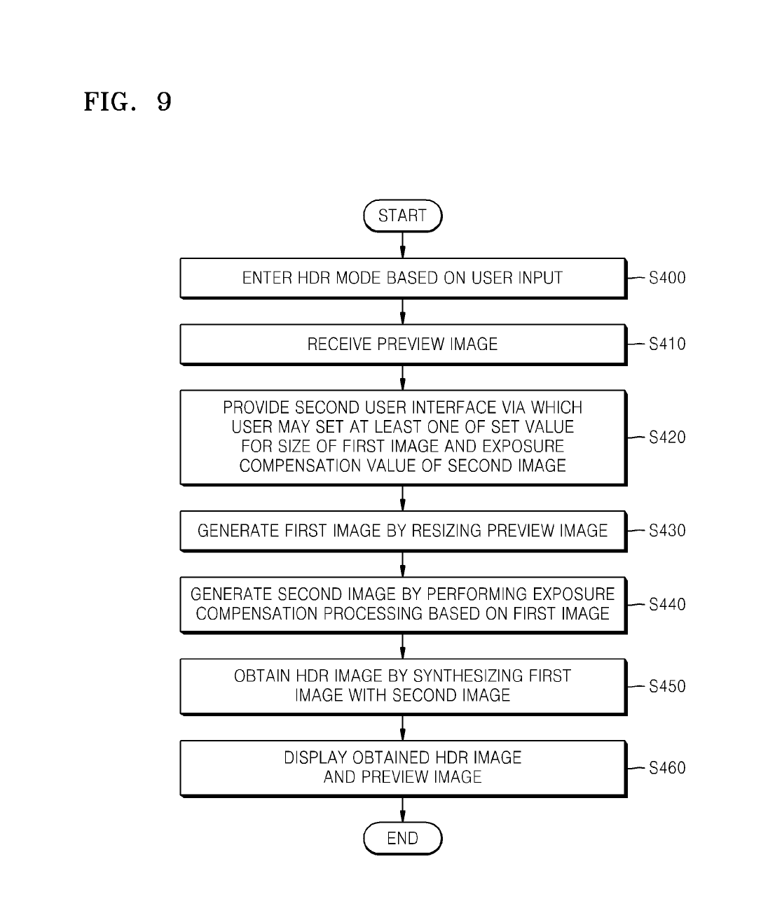

FIG. 9 is a flowchart of a method of obtaining a HDR image based on a user input according to an embodiment.

Operations S400 and S410 correspond to operations S300 and S310 shown in FIG. 7 and described above. Thus, a detailed description thereof will not be provided here.

In operation S420, the digital imaging apparatus 1000 provides a second interface, via which a user may set at least one of a set value for a size of a first image or an exposure compensation value for a second image.

For example, the first image may be converted to have a smaller size than the preview image. A width value, a height value, or both for the first image may be used as a set value for a size of the first image.

Additionally, information about a spacing between exposure values of the first image and the second image may be necessary as an exposure compensation value of the second image.

Accordingly, by providing a second interface, via which a user may set a desired set value for a HDR, the user may easily and quickly identify various desired HDR images with a preview image together.

Operations S430 through S460 correspond to operations S320 through S350 shown in FIG. 7 and described above. Thus, a detailed description thereof will not be provided here.

FIG. 10 illustrates an example of displaying a second user interface 400, via which a user may set a set value for an HDR image, on the display unit 50, which is performed by the digital imaging apparatus 1000 according to an embodiment.

As shown in FIG. 10, the digital imaging apparatus 1000 may provide the second user interface 400, via which a user may set a set value for a HDR image, together with the preview image 100. Thus, the user may easily obtain a desired HDR image.

For example, as shown in FIG. 10, the second user interface 400 includes a field 420 for setting set values for a size of a first image. so that a user may set a width value and a height value of a HDR image.

Additionally, as shown in FIG. 10, the second user interface 400 includes a field 410 for setting an exposure compensation value of a second image. so that a user may set a dynamic range of a HDR image.

Operations of the digital imaging apparatus 1000 are described in detail.

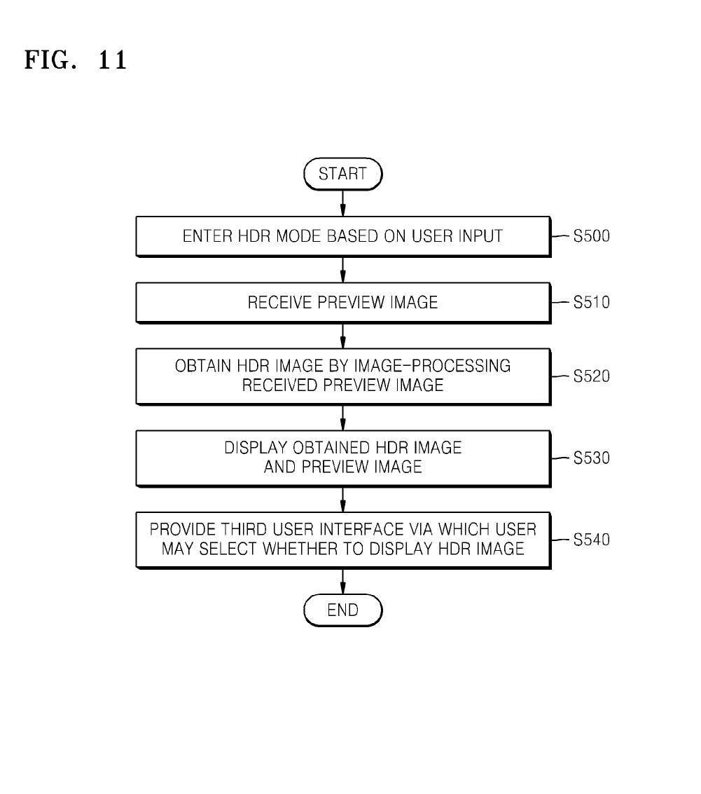

FIG. 11 is a flowchart of a method of displaying a HDR image based on a user input, according to an embodiment.

Operations S500 through S530 correspond to operations S100 through S130 shown in FIG. 1 and described above. Thus, a detailed description thereof will not be provided here.

In operation S540, the digital imaging apparatus 1000 provides a third interface, via which a user may select whether to display a HDR image. The third interface is described in detail with reference to FIG. 12.

FIG. 12 illustrates an example of displaying a third user interface 500, via which a user may select whether to display an HDR image, on the display unit 50, which is performed by the digital imaging apparatus 1000 according to an embodiment.

As shown in FIG. 12, while the digital imaging apparatus 1000 displays the preview image 100 and the HDR image 300 together on the display unit 50, the control unit 40 may control to display the third user interface 500, via which a user may select whether to display the HDR image, on the display unit 50.

For example, if a user selects “Yes” from the third user interface 500, the control unit 40 may control to continuously display the preview image 100 and the HDR image 300 on the display unit 50 included in the digital imaging apparatus 1000.

On the contrary, if a user selects “No” from the third user interface 500, the control unit 40 may control to display only the preview image 100 on the display unit 50 included in the digital imaging apparatus 1000.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

It should be understood that the exemplary embodiments described therein should be considered in a descriptive sense only and not for purposes of limitation. Descriptions of features or aspects within each embodiment should typically be considered as available for other similar features or aspects in other embodiments.

While various embodiments have been described with reference to the figures, it will be understood by those of ordinary skill in the art that various changes in form and details may be made therein without departing from the spirit and scope of the present description as defined by the following claims.

What is claimed is:

1. A method of displaying a high dynamic range (HDR) image, the method comprising:
entering an HDR mode based on a user input;
receiving a preview image;
obtaining an HDR image based on the received preview image; and
displaying the obtained HDR image and the preview image together.

2. The method of claim 1, further comprising providing a first user interface, via which a user may select whether to enter the HDR mode.

3. The method of claim 1, wherein the obtaining of the HDR image comprises:
generating a first image by resizing the preview image;
generating a second image by performing exposure compensation processing based on the generated first image; and
obtaining the HDR image by synthesizing the first image with the second image.

4. The method of claim 3, further comprising providing a second user interface, via which a user may set at least one of a set value for a size of the first image or an exposure compensation value of the second image.

5. The method of claim 1, further comprising providing a third user interface, via which a user may select whether to display the HDR image.

6. A digital imaging apparatus comprising:
a user input unit that receives an input of a signal for entering a high dynamic range (HDR) mode;
an image reception unit that receives a preview image;
an imaging unit that obtains an HDR image by image-processing the preview image that is received by the image reception unit; and
a control unit that controls to display the HDR image, which is obtained by the imaging unit, and the preview image together on a display unit.

7. The digital imaging apparatus of claim 6, wherein the control unit controls to display a first user interface, via which a user may select whether to enter the HDR mode, on the display unit, and
the user input unit receives an input of a selection of whether to enter the HDR mode.

8. The digital imaging apparatus of claim 6, wherein the imaging unit comprises:
a resizing unit that resizes the preview image that is received by the image reception unit, and thus generates a first image;
an exposure compensation processing unit that performs exposure compensation processing based on the first image that is generated by the resizing unit, and thus generates a second image; and
an image synthesis unit that synthesizes the first image that is generated by the resizing unit with the second image that is generated by the exposure compensation processing unit, and thus obtains the HDR image.

9. The digital imaging apparatus of claim 8, wherein the control unit controls to display a second user interface, via which a user may set at least one of a set value for a size of the first image or an exposure compensation value for the second image, on the display unit, and
the user input unit receives an input of a selection of at least one of a set value for a size of the first image and an exposure compensation value for the second image, on the display unit.

10. The digital imaging apparatus of claim 6, wherein the control unit controls a third user interface, via which a user may select whether to display the HDR image, on the display unit. and
the user input unit receives an input of the selecting of whether to display the HDR image.

11. A non-transitory computer-readable storage medium having stored thereon a computer program, which when executed by a computer, performs a method of displaying a high dynamic range (HDR) image, the method comprising:
entering an HDR mode based on a user input;
receiving a preview image;
obtaining an HDR image based on the received preview image; and
displaying the obtained HDR image and the preview image together.

12. The non-transitory computer-readable storage medium of claim 11, wherein the method further comprises providing a first user interface, via which a user may select whether to enter the HDR mode.

13. The non-transitory computer-readable storage medium of claim 11, wherein the obtaining of the HDR image comprises:
generating a first image by resizing the preview image;
generating a second image by performing exposure compensation processing based on the generated first image; and
obtaining the HDR image by synthesizing the first image with the second image.

14. The non-transitory computer-readable storage medium of claim 13, wherein the method further comprises providing a second user interface, via which a user may set at least one of a set value for a size of the first image or an exposure compensation value of the second image.

15. The non-transitory computer-readable storage medium of claim 11, wherein the method further comprises providing a third user interface, via which a user may select whether to display the HDR image.

16. The method of claim 1, wherein at least one of a location or a size of the HDR image, which is displayed with the preview image together, is changeable based on a user input.

17. The digital imaging apparatus of claim 6, wherein at least one of a location or a size of the HDR image, which is displayed with the preview image together, is changeable based on a user input.

18. The non-transitory computer-readable storage medium of claim 11, wherein at least one of a location or a size of the HDR image, which is displayed with the preview image together, is changeable based on a user input.
